(19) United States
(12) Patent Application Publication
(10) Pub. No.: US 2007/0159479 A1
(43) Pub. Date: Jul. 12, 2007

(54) Mapping and drawing method for a tetrahedron map

(76) Inventor: Hung-Chien Liao, Taoyuan Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/326,498

(22) Filed: Jan. 6, 2006

(51) Int. Cl. G06T 15/20

(52) U.S. Cl. 345/427

(57) ABSTRACT

This invention relates to a drawing method for Tetrahedron Mapping, a tetrahedron map formed by equilateral triangles is converted to relative positions of two dimensional planar image and three dimensional object, then project each object in three dimensional space from the tetrahedron center to tetrahedron map on two dimensional plane, wherein the image and drawing can be mapped to the tetrahedron map along with elements such as: color, transparency, depth and reflecting material, etc.

### BACKGROUND OF THE INVENTION

1. Field of the Invention

This invention relates to a mapping and drawing method for a tetrahedron map, it more specifically relates to the corresponding positions when a tetrahedron map formed by four equilateral triangles, and each object in three dimensional space is projected onto the tetrahedron map of a two dimensional plane from the center of a tetrahedron, the image and drawing can be mapped to the tetrahedron map along with elements such as: color, transparency, depth and reflecting material, etc.

2. Description of the Prior Art

The current computer environmental mapping principle is widely used in the computer three dimensional drawing, this kind of application can be commonly seen from the computer drawing software to computer games, along with the enhancement in computer performance, we have higher and higher requirement on image quality, we can thus predict that each drawing will be become more and more complicated; however, problems such as the giant computational load, data access and display memory bandwidth, have made most computers difficult to meet the requirements in three dimensional drawing, therefore, how to develop a new idea and concept to solve the above-mentioned problem is what really bothers the professional a lot.

Computer environmental mapping provides a method to process and define the detailed image of massive drawings, it is usually used to represent a phenomenon that an object reflecting its surrounding environment, and many environmental mapping technologies and principles are invented and applied, however, most of them have some troubles, for example, serious resolution distortion, or complicated computation. And the current most frequently used principle in computer environment mapping is cubic environment mapping, wherein a three dimensional object is projected onto six planes; that is, a cubic is used to enclose a three dimensional object, by doing so, each face of the three dimensional object can be well taken care and the resolution distortion will become less serious. Most importantly, this method is still an expensive computing if we want to change it dynamically, which might cause inconvenience to the user. Therefore, how to set up a new computational technique and principle is the current most important topic, through such technique and principle, we can improve the complicated computation and improve the delay phenomenon due to high speed computation, or improve the inability of computer to be used in executing too complicated and giant mathematical computation.

### SUMMARY OF THE INVENTION

Use the above cubic as a basis, we can obtain relative position of three dimensional object environment mapping, many formulas are generated through such an action, however, tetrahedron is the simplest stereo object, use tetrahedron as an technical principle, we can calculate the relative positions of a three dimensional object environment mapping, two faces of computations for generating environment map can be saved as compared to cubic environment mapping. Excessive formulas generated in the cubic environment mapping can thus be simplified, and the computational speed and efficiency can be enhanced, therefore, the computational load of the computer can be reduced and the memory bandwidth as well as the computer hardware cost can thus be reduced.

Left hand rule is used to explain the rotational angle of each vector. Two main steps are included:

First step, generate a tetrahedron map; tetrahedron is installed at the tetrahedron local coordinate space with certain angle, the fixed angle can be at any angle on the local coordinate space of the tetrahedron, the tetrahedron is formed by four equilateral triangles, each render is performed from the center of the tetrahedron to each triangle, and the data is stored in one texture to obtain a tetrahedron map;

The second step, corresponding information is taken out from the tetrahedron map; the information is combined with the view matrix, perspective matrix and texture coordinate scale matrix corresponded to each triangle, a combo matrix of four triangles is thus formed, four face center vectors can be obtained from the center of the tetrahedron to the center of each corresponding triangle, then perform dot product calculation on the vertex and four face center vectors of the local coordinate space of the tetrahedron, from the maximum value we know that the vertex is located at the triangle corresponded to the maximum value, then the vertex coordinate is multiplied by the corresponding triangle combo matrix, through such computation we can convert them to planar texture coordinate, from the planar texture coordinate we can obtain the corresponding information of the three dimensional object on the planar tetrahedron.

Finally, the drawing information needed in the three dimensional drawing is thus obtained, due to the simplification on the mathematical formulas; we can enhance the computational speed and efficiency, reduce the computational load, reduce the memory bandwidth and reduce the computer hardware cost.

### BRIEF DESCRIPTION OF THE DRAWINGS

FIG. 1 is a perspective view drawing of a tetrahedron of the current invention.

FIG. 2 is a perspective view drawing of a tetrahedron of the current invention viewed at another angle.

FIG. 3 is a perspective view drawing of a tetrahedron of the current invention viewed at another angle.

FIG. 4 is an expanded planar drawing of the real object of a tetrahedron of the current invention.

FIG. 5 is a perspective view drawing of the current invention viewed at the center of the tetrahedron.

FIG. 6 is a top view drawing of the current invention viewed at the center of the tetrahedron.

FIG. 7 is a front side view drawing of the current invention viewed at the center of the tetrahedron.

FIG. 8 is a right side view drawing of the current invention viewed at the center of the tetrahedron.

FIG. 9 is a perspective view drawing of the first color camera frustum of the current invention.

FIG. 10 is a perspective view drawing of the second color camera frustum of the current invention.

FIG. 11 is a perspective view drawing of the third color camera frustum of the current invention.

FIG. 12 is a perspective view drawing of the fourth color camera frustum of the current invention.

FIG. 13 is the process flow to generate tetrahedron map of the current invention.

FIG. 14 is a tetrahedron map of the current invention.

FIG. 15 is a display drawing of the four face center vector of a tetrahedron of the current invention.

FIG. 16 is the process flow for fetching data from the tetrahedron map of the current invention.

### DETAILED DESCRIPTION OF THE PREFERRED EMBODIMENT

Regarding the principles, techniques adopted by this invention and the performance reached, the left hand rule will be used as a basis to explain the rotational angle of each vector of the current invention, one better embodiment accompanied with detailed drawings for detailed descriptions; one can have a better understanding of the current invention.

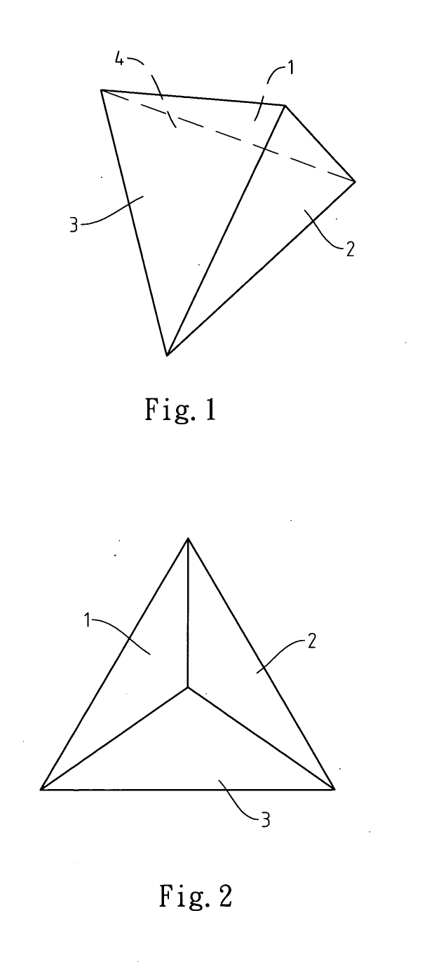

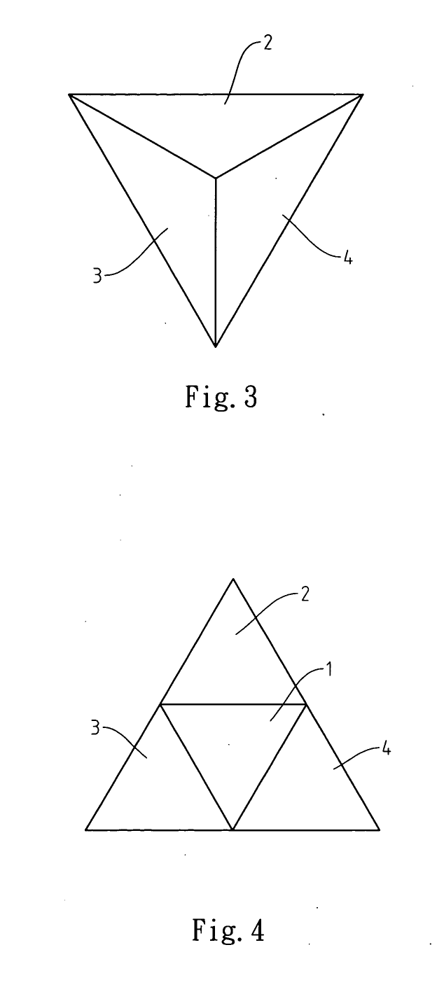

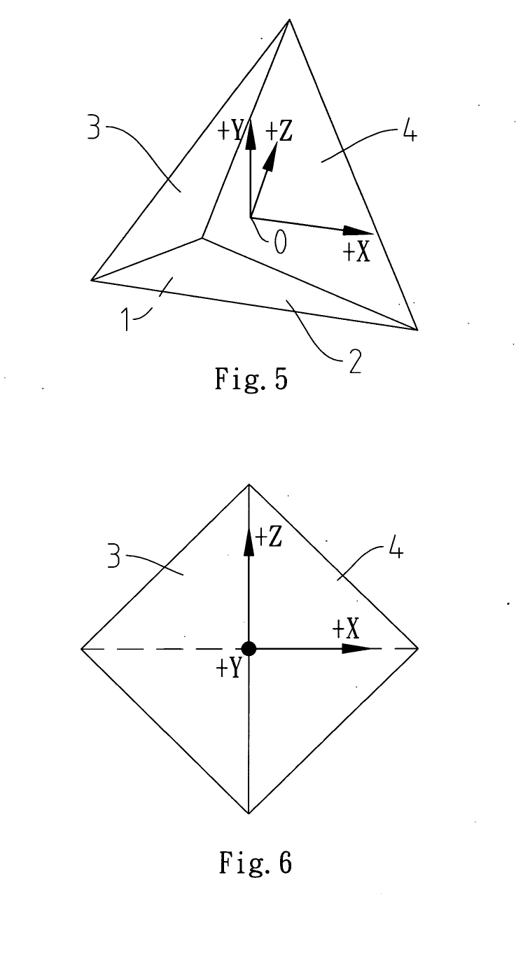

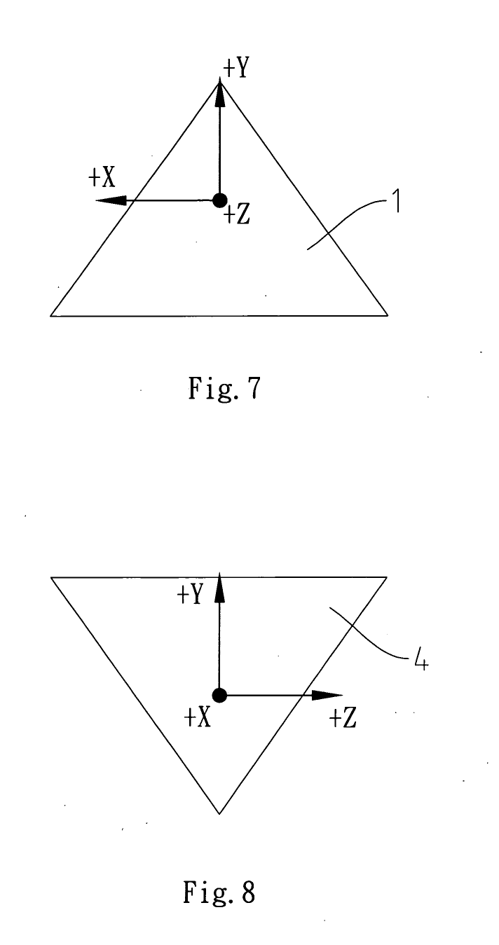

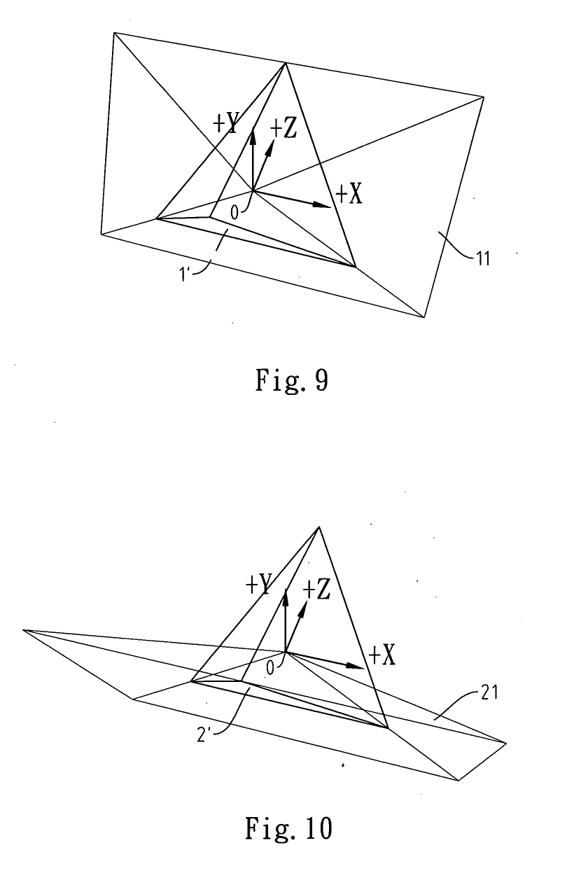

Please refer to FIG. 1 to FIG. 8, tetrahedron is installed at the local tetrahedron space with fixed angle, the fixed angle can be at any angle in the local tetrahedron space, the tetrahedron is formed by four equilateral triangles 1, 2, 3, 4.

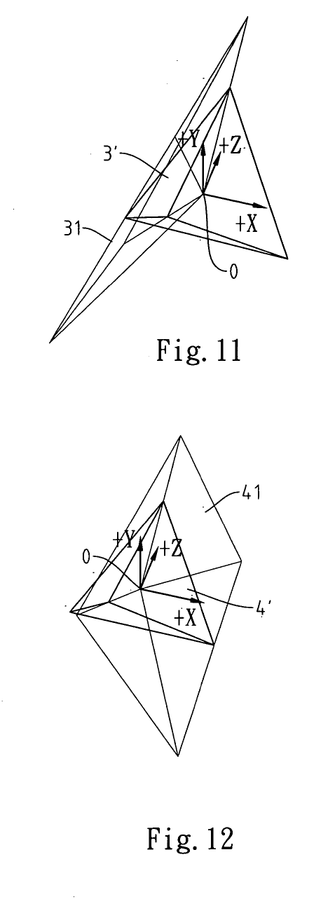

Please refer to FIG. 9 to 12, from the central origin of tetrahedron to each equilateral triangle 1, 2, 3, 4, we will obtain four camera frustums (camera frustum) 11, 21, 31, 41, camera frustums 11, 21, 31, 41 will include corresponding equilateral triangles 1, 2, 3, 4, therefore, first color triangle1′, second color triangle2′, third color triangle3′, fourth color triangle4′ are obtained.

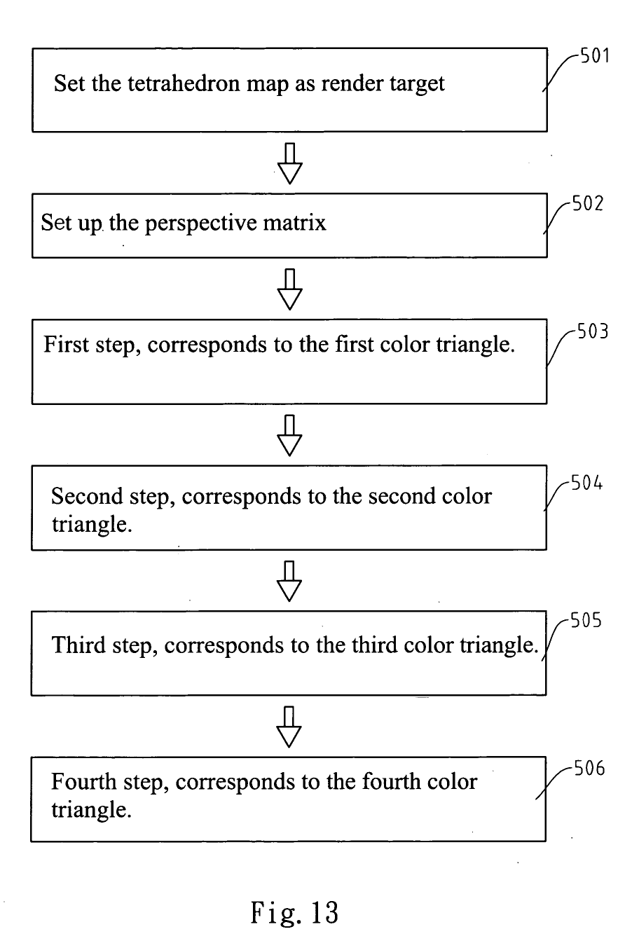

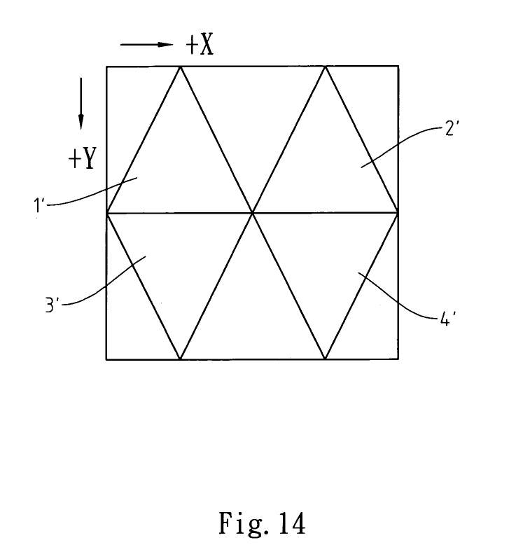

Please refer to FIG. 13 to FIG. 14. Step 501 is to set up the tetrahedron map in the computer memory buffer zone as the render target. Step 502 is to set up the field of view of the perspective matrix to be 143.98570868 degrees in the X axis and 125.2648968 degrees in the Y axis. In step 503, corresponds to first color triangle1′, the screen view port of the flat panel display is set up, for the X axis, from coordinate 0 to the half width of tetrahedron map, and for the Y axis of screen view port, from coordinate 0 to the half height of tetrahedron map, an view matrix of first color camera frustum 11 from position (0,0,0) to look-at vector (0,−0.45970085,0.8880738), and up vector is (0,1,0), then perform render on the virtual object within the range of first color camera frustum 11, first color triangle 1′ will then store the necessary data in the tetrahedron map. For step 504, corresponds to second color triangle2′, then set up the screen view port of the flat panel display, it is the half width of tetrahedron map to one width of tetrahedron map in the X axis, and from coordinate 0 to half of the height of tetrahedron map, the view matrix of second color camera frustum 21 from (0,0,0) to look-at vector (0,−0.45970085,−0.8880738), and up vector is (0,1,0), then perform render on all the virtual objects within the second color camera frustum 21, second color triangle 2′ will stores the necessary data in the tetrahedron map. Step 505 is to correspond the third color triangle 3′, then set up the screen view port of the flat panel display, it is from coordinate 0 of the tetrahedron map to the half width of the tetrahedron map in the X axis, it is from the half height of the tetrahedron map to one tetrahedron map height in the Y axis, set up the view matrix of third color camera frustum 31 to starts from position (0,0,0) to look-at vector (−0.8880738,0.45970085,0), the up vector is (0,1,0), then perform render on all the virtual objects within the third color camera frustum 31, third color triangle 3′ will store the necessary data in the tetrahedron map. Step 506 is to correspond the fourth color triangle4′, set up the screen view port of the flat panel display, it is from half width of the tetrahedron map to one width of the tetrahedron map in the X axis, it is from the half height of the tetrahedron map to one tetrahedron map height in the Y axis, set up the view matrix of the fourth color camera frustum 41 from position (0,0,0) to look-at vector (0.8880738,0.45970085,0) and up vector is (0,1,0), then perform render on all the virtual objects within the fourth color camera frustum 41, fourth color triangle 4′ will the store the necessary data in the tetrahedron map, a tetrahedron map similar to FIG. 14 will be obtained through the above-mentioned steps.

The second big step is to fetch out corresponding information from the tetrahedron map; the flat panel display coordinate is thus converted through such computation.

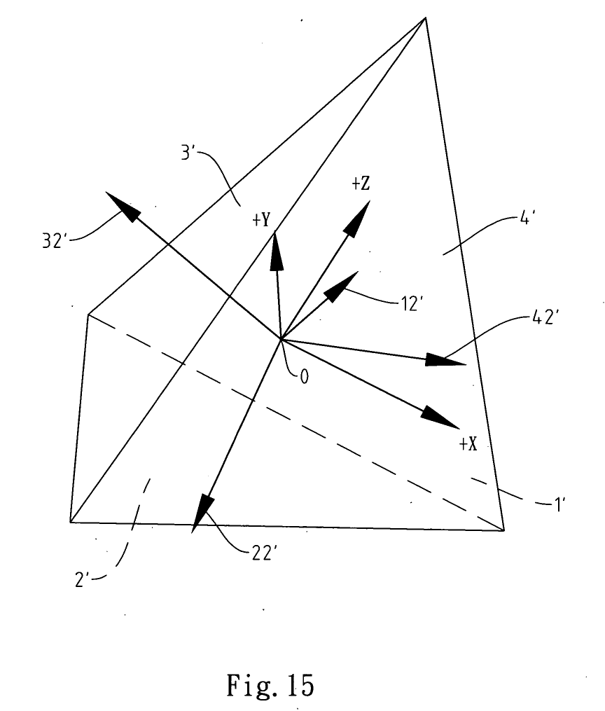

Please refer to FIG. 15, first, each corresponding view matrix, perspective matrix and texture coordinate scale matrix are combined to form four corresponding first color triangle combo matrix, second color triangle combo matrix, third color triangle combo matrix, fourth color triangle combo matrix, four face center vectors will be obtained from the tetrahedron center to each corresponding triangle center, this face center vector is perpendicular to each corresponding triangle.

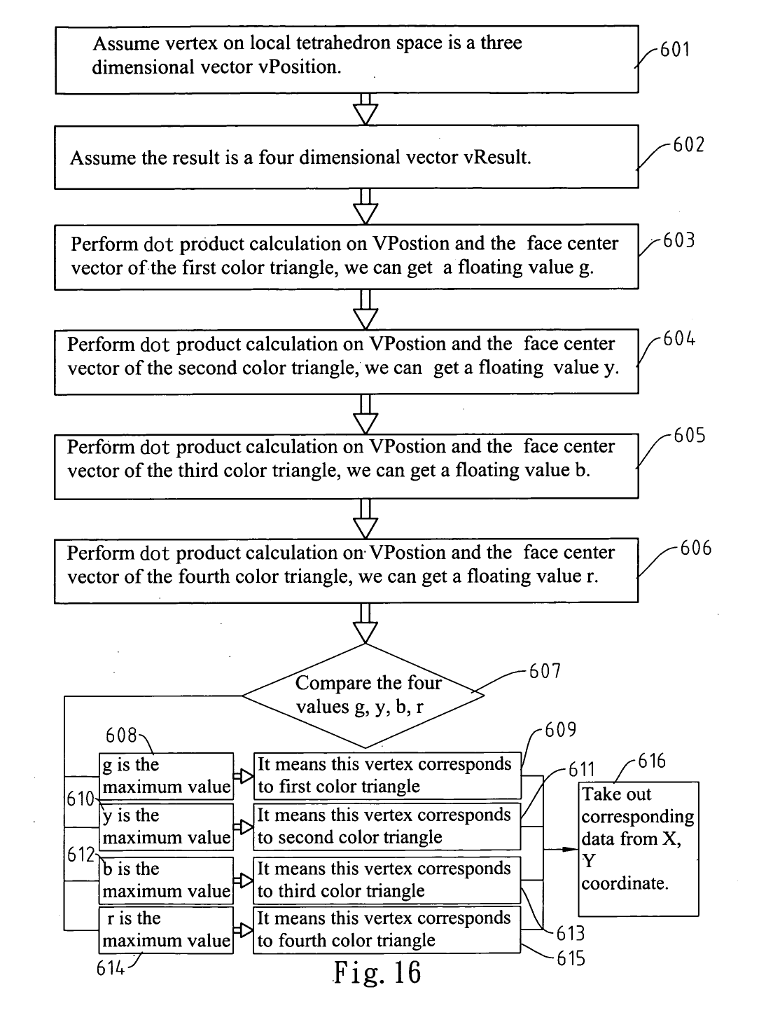

Please refer to FIG. 16, step 601 assumes a vertex calls V POSITION on the local tetrahedron space is a three dimensional vector. Step 602 assumes the computational result V POSITION has a four dimensional vector called V RESULT. Then step 603 is to perform dot product calculation on the V POSITION and the face center vectorl2′ of the first color triangle to obtain a floating point value g. Step 604 is to perform dot product calculation on the V POSITION and the face center vector22′ of the second color triangle to obtain a floating point value y. Step 605 is to perform dot product calculation on the V POSITION and face center vector32′ of the third color triangle to obtain floating point value b. Step 606 is to perform dot product calculation on V POSITION and the face center vector42′ of the fourth color triangle to obtain a floating point value r. Step 607 is to compare four floating point values of g, y, b, r. In step 608, if floating point value g is a maximum value, step 609 will be entered directly. Step 609 means this vertex corresponds to first color triangle, use the coordinate x, y, z of V POSITION plus the fourth vector value w of 1.0 to multiply the first color triangle combo matrix, we will obtain the V RESULT. In step 610, if floating point value y is the maximum value, step 611 will be entered directly. Step 611 means this vertex corresponds to second color triangle, use the coordinate x, y, z of V POSITION plus the fourth vector value w of 1.0 to multiply the second color triangle combo matrix, we will obtain the V RESULT. In step 612, if floating point value b is a maximum value, step 613 will be entered directly. Step 613 means this vertex corresponds to third color triangle, use the coordinate x, y, z of V POSITION plus the fourth vector value w of 1.0 to multiply the third color triangle combo matrix, we will obtain the V RESULT. In step 614, if the floating point value r is a maximum value, step 615 will be entered directly. Step 615 means this vertex corresponds to fourth color triangle, use the coordinate x, y, z of V POSITION plus the fourth vector value w of 1.0 to multiply the fourth color triangle combo matrix, we will obtain the V RESULT. In step 616, the x value of V RESULT will be divided by the w value of V RESULT to obtain the X coordinate on the tetrahedron map, divide the y value of the V RESULT by the w value of the V RESULT to obtain the Y coordinate on tetrahedron map, take out the necessary corresponding information form the X, Y coordinate of tetrahedron map.

Therefore, the needed drawing for three dimensional drawing will be obtained, due to the simplification in the mathematical formula, the computational speed and efficiency is enhanced, the computational load of the computer can be reduced and the memory bandwidth as well as the computer hardware cost can be reduced, too.

What the invention claimed is:

1. A corresponding mapping and drawing method for a tetrahedron, each object in three dimensional space is projected from the center of tetrahedron to the a tetrahedron in two dimensional plane, wherein the image and drawing can be mapped to the tetrahedron map along with elements such as: color, transparency, depth and reflecting material, etc., through the following steps:
Generating tetrahedron map: performing one render from tetrahedron center to each triangle and storing the data in one texture to generate tetrahedron map;
Withdrawing corresponding information from tetrahedron: combine each corresponding view matrix, perspective matrix and texture scale coordinate matrix to form four triangles combo matrixes, four face center vectors will be obtained from the tetrahedron center to the center of each corresponding triangle, perform dot product calculation on the vertex of the local coordinate space of the tetrahedron with the four face center vectors, we know from the maximum value that the vertex is located at the corresponding maximum value triangle, then multiply the vertex coordinate by the combo matrix of corresponding triangle, through such computation, we are able to convert them into planar texture coordinate, through the planar texture coordinate, we are able to acquire the corresponding information of the three dimensional object on the planar tetrahedron map.

2. The mapping and drawing method for a tetrahedron of claim 1 wherein the above-mentioned tetrahedron is formed by four equilateral triangles.

3. The mapping and drawing method for a tetrahedron of claim 1 wherein the above-mentioned tetrahedron is installed at the local coordinate of the tetrahedron with fixed angle.

4. The mapping and drawing method for a tetrahedron of claim 3 wherein the above-mentioned tetrahedron is installed at the local coordinate of the tetrahedron with fixed angle; the fixed angle can be any angle on the local coordinate of the tetrahedron.

5. The mapping and drawing method for a tetrahedron of claim 1 wherein render is performed from the above-mentioned tetrahedron center to each triangle, four camera frustums can be obtained from the central coordinate of tetrahedron to each equilateral triangle, camera frustum will include corresponding equilateral triangle, first color triangle, second color triangle, third color triangle and fourth color triangle are thus divided.

6. The mapping and drawing method for a tetrahedron of claim 1 wherein method used to generate tetrahedron should at least include the following steps:
A tetrahedron map is set up within the memory buffer zone as a render target;
A perspective matrix is set up wherein field of view forms an angle between x axis and y axis;
Field of view is corresponded to first color triangle;
Screen view port of the flat panel display is set up; define the render relative position on the tetrahedron map for x axis and y axis;
Setting up a view matrix of camera frustum, the view matrix is from the central coordinate to look-at vector, wherein an up vector is included;
Performing render on all the virtual objects within the first color camera frustum, first color triangle will then store the necessary data into the tetrahedron map;
Corresponding field of view to second color triangle;
Setting up screen view port for flat panel display and defining the render relative position on the tetrahedron map for x axis and y axis;
Setting up the view matrix for camera frustum, the view matrix is from the central coordinate to look-at vector, wherein an up vector is included;
Performing render on all the virtual objects within the second color camera frustum, second color triangle will then store the necessary data into the tetrahedron map;
Corresponding field of view to third color triangle;
Setting up screen view port for flat panel display and defining the render relative position on the tetrahedron map for x axis and y axis;
Setting up the view matrix for camera frustum, the view matrix is from the central coordinate to look-at vector, wherein an up vector is included;
Performing render on all the virtual objects within the third color camera frustum, third color triangle will then store the necessary data into the tetrahedron map;
Corresponding field of view to fourth color triangle;
Setting up screen view port for flat panel display and defining the render relative position on the tetrahedron map for x axis and y axis;
Setting up the view matrix for camera frustum, the view matrix is from the central coordinate to look-at vector, wherein an up vector is included; and
Performing render on all the virtual objects within the fourth color camera frustum, fourth color triangle will then store the necessary data into the tetrahedron map.

7. The mapping and drawing method for a tetrahedron of claim 6 wherein the above-mentioned perspective matrix and view matrix will combine to form camera frustum which will enclose the corresponding triangle, based on such premise, the field of view of the perspective matrix can be of any size.

8. The mapping and drawing method for a tetrahedron of claim 6 wherein the above-mentioned perspective matrix and view matrix will combine to form camera frustum which will enclose the corresponding triangle, based on such premise, look-at vector and up vector of view matrix of camera frustum can be of any values.

9. The mapping and drawing method for a tetrahedron of claim 1 wherein the methods used to withdraw corresponding data of tetrahedron map include at least the following steps:
Combining each corresponding view matrix, perspective matrix and texture coordinate scale matrix to form four corresponding first color triangle combo matrix, second color triangle combo matrix, third color triangle combo matrix, fourth color triangle combo matrix;
Four face center vectors will be obtained from the tetrahedron center to each of the corresponding triangle center; this face center vector will be perpendicular to each corresponding triangle;
Assuming vertex of local coordinate space of tetrahedron as a three dimensional vector called V POSITION;
Assuming computational result, V POSITION will have a four dimensional vector called V RESULT;
Performing dot product calculation on V POSITION and face center vector of the first color triangle to obtain a floating point value g;
Performing dot product calculation on V POSITION and face center vector of the second color triangle to obtain a floating point value y;
Performing dot product calculation on V POSITION and face center vector of the third color triangle to obtain a floating point value b;
Performing dot product calculation on V POSITION and face center vector of the fourth color triangle to obtain a floating point value r;
Using computer to compare four floating points values g, y, b, and r;
When floating point value g is. a maximum value, this means vertex is corresponded to first color triangle, add the coordinate value x, y, z of V POSITION with a fourth vector value w of 1.0 and multiply the first color triangle combo matrix to obtain V RESULT;
When floating point value y is a maximum value, this means vertex is corresponded to second color triangle, add the coordinate value x, y, z of V POSITION with a fourth vector value w of 1.0 and multiply the second color triangle combo matrix to obtain V RESULT;
When floating point value b is a maximum value, this means vertex is corresponded to third color triangle, add the coordinate value x, y, z of V POSITION with a fourth vector value w of 1.0 and multiply the third color triangle combo matrix to obtain V RESULT;
When floating point value r is a maximum value, this means vertex is corresponded to fourth color triangle, add the coordinate value x, y, z of V POSITION with a fourth vector value w of 1.0 and multiply the fourth color triangle combo matrix to obtain V RESULT; and
Divide the x values of V RESULT by the w value of V RESULT to obtain the X coordinate on the tetrahedron map, divide the y value of the V RESULT by the w value of the V RESULT to obtain the Y coordinate on the tetrahedron map, withdraw the corresponding information from X, Y coordinate of tetrahedron map and withdraw the corresponding information from the texture.

10. The mapping and drawing method for a tetrahedron of claim 9 wherein the above-mentioned w value of 1.0 is used to take into account the V POSITION.
